(19) United States
(12) Patent Application Publication
(10) Pub. No.: US 2026/0196044 A1
(43) Pub. Date: Jul. 9, 2026

(54) APPARATUS AND METHOD FOR TRAINING EVENT SPOTTING MODEL USING PSEUDO-SPATIAL DATA

(71) Applicant: KOREA INSTITUTE OF SCIENCE AND TECHNOLOGY, Seoul (KR)

(72) Inventors: Jinwook KIM, Seoul (KR); Kyung-Ryoul MUN, Seoul (KR); Ankhzaya JAMSRANDORJ, Seoul (KR); Yin May Oo N/A, Seoul (KR); Vanyi CHAO, Seoul (KR); Hoang Quoc NGUYEN, Seoul (KR)

(73) Assignee: KOREA INSTITUTE OF SCIENCE AND TECHNOLOGY, Seoul (KR)

(21) Appl. No.: 19/075,040

(22) Filed: Mar. 10, 2025

(30) Foreign Application Priority Data
Jan. 8, 2025 (KR) 10-2025-0002713

(51) Int. Cl. G06V 20/40; G06T 7/70; G06V 10/46; G06V 10/77; G06V 10/774

(52) U.S. Cl. CPC G06V 20/44; G06T 7/70; G06V 10/46; G06V 10/7715; G06V 10/774; G06V 20/42; G06T 2207/10016; G06T 2207/20081; G06T 2207/30224

(57) ABSTRACT

Disclosed herein is an apparatus for training a spatiotemporal event spotting model, according to an embodiment. The apparatus may train the model to: detect respective spatial information on one or more objects in a target video that includes one or more frames, in which the one or more objects include at least one of a first object, a second object, or a third object; generate pseudo-spatial data of a target object in the target video based on the one or more spatial information, in which the target object is one of the objects belonging to the one or more objects; and generate spatiotemporal information on an event related to the target object, which has a pair of pseudo-spatial data of the target object and temporal information at the time of detection.

### FIELD OF THE INVENTION

The disclosed embodiments relate to a technique for training an event spotting model using pseudo-spatial data.

More specifically, the disclosed embodiments relate to a technique for training an artificial intelligence model to spatially and temporally spot events occurring in an input video using training data that includes pseudo-spatial data.

### Description of Government-Sponsored Research

This research was conducted with the support of the Ministry of Culture, Sports and Tourism [Project Number: 2370000074, Subproject Number: KC000844, Project Title: Development of Athlete Training and Competition Data Management and AI-based Performance Enhancement Solution Technology].

### DESCRIPTION OF THE RELATED ART

Various analyses are being conducted to enhance sports performance. For example, an instance of this is quantifying the performance of athletes in sports game footage into data. However, the vast amount of data in sports game presents a challenge in terms of processing.

Some studies aim to address this issue by integrating artificial intelligence into sports game analysis technology. A model for automatically detecting events occurring during a game has been proposed. However, building the training data required excessive costs.

Events in sports game may only be detected when both spatial and temporal information are provided. However, spatial information is difficult to detect. This is because the flow of the sports game unfolds rapidly, and due to the limitations of camera angles, the positions of objects may be obscured.

The training data for an event spotting model needs to include data related to when and where the event occurred, in other words, the spatial and temporal information on the event needs to be detected. However, the spatial and temporal information on objects or events comes with the aforementioned limitations, resulting in a lack of practical detectability.

### Documents of Related Art

(Patent Document 1) Korean Patent Application Laid-Open No. 10-2022-0094529

### SUMMARY OF THE INVENTION

The disclosed embodiments are intended to train an event spotting model using pseudo-spatial data.

There is provided an apparatus for training a spatiotemporal event spotting model, according to an embodiment. The apparatus may include: one or more processors; and a memory storing instructions executed by the one or more processors, in which the one or more processors may: detect respective location information on one or more objects in a target video that includes one or more frames, in which the one or more objects include at least one of a first object, a second object, or a third object; generate pseudo-spatial data of a target object in the target video based on the one or more location information, in which the target object is one of the objects belonging to the one or more objects; and generate spatiotemporal information on an event related to the target object, which has a pair of pseudo-spatial data of the target object and temporal information at the time of detection.

The one or more processors may train the model to extract the spatiotemporal information on the event in the input video, based on the spatiotemporal information on the event, when an input video is input to the model.

The one or more processors may train the model to represent the spatiotemporal information on the event in a three dimensional (3D) heatmap format.

The spatiotemporal information on the event may include: temporal information including an occasion when the event occurred in each frame; and spatial information including location coordinates where the event occurred in each frame.

The 3D heatmap may be configured to include an x-axis and a y-axis of a pixel coordinate system applied to the target video, and a time axis (t-axis) of the target video.

The target video may be a video capturing a ball sports game, the first object may be a ball, and the one or more processors may detect location information on the ball and generate spatial information on the first object based on the location information on the ball.

The second object may be a referee, and the one or more processors may detect a gaze direction in which the referee is looking at the ball and generate spatial information on the second object based on the gaze direction of the referee.

The third object may be a player possessing the ball, and the one or more processors may detect location information on the player and generate spatial information on the third object based on the location information on the player.

The one or more processors may generate pseudo-location information on the first object based on at least one of the spatial information on the first object, the spatial information on the second object, or the spatial information on the third object.

There is provided a method of training a spatiotemporal event spotting model, according to an embodiment. The method, performed by an apparatus for training a spatiotemporal event spotting model, including one or more processors, and a memory storing instructions executed by the one or more processors, may include: detecting respective location information on one or more objects in a target video that includes one or more frames, in which the one or more objects include at least one of a first object, a second object, or a third object; generating pseudo-spatial data of a target object in the target video based on the one or more location information, in which the target object is one of the objects belonging to the one or more objects; and generating spatiotemporal information on an event related to the target object, which has a pair of pseudo-spatial data of the target object and temporal information at the time of detection.

The method may further include: training the model to extract the spatiotemporal information on the event in the input video, based on the spatiotemporal information on the event, when an input video is input to the model.

The training may include: training the model to represent the spatiotemporal information on the event in a three dimensional (3D) heatmap format.

The spatiotemporal information on the event may include: temporal information including an occasion when the event occurred in each frame; and spatial information including location coordinates where the event occurred in each frame.

The 3D heatmap may be configured to include an x-axis and a y-axis of a pixel coordinate system applied to the target video, and a time axis (t-axis) of the target video.

The target video may be a video capturing a ball sports game, and the first object may be a ball, in which the detecting may include: detecting location information on the ball, and the generating may include: generating spatial information on the first object based on the location information on the ball.

The second object may be a referee, in which the detecting may include: detecting a gaze direction in which the referee is looking at the ball, and the generating may include: generating spatial information on the second object based on the gaze direction of the referee.

The third object may be a player possessing the ball, in which the detecting may include: detecting location information on the player, and the generating may include: generating spatial information on the third object based on the location information on the player.

The generating may include: generating pseudo-location information on the first object based on at least one of the spatial information on the first object, the spatial information on the second object, or the spatial information on the third object.

The disclosed embodiments use approximate pseudo-spatial data instead of exact location coordinates for the spatial information on events used as training data. This simplifies the construction of training data, thereby reducing the time and cost required for training.

The disclosed embodiments use incomplete pseudo-spatial data instead of exact location coordinates, even when it is not possible to detect exact location coordinates for the spatial information on events used as training data. This helps improve the completeness of the training data.

### BRIEF DESCRIPTION OF THE DRAWINGS

FIG. 1 is a block diagram for describing an apparatus for training a spatiotemporal event spotting model according to an embodiment.

FIG. 2 is a block diagram for describing the modules of the apparatus for training a spatiotemporal event spotting model according to an embodiment.

FIG. 3 is a block diagram for describing the detailed modules of the apparatus for training a spatiotemporal event spotting model according to an embodiment.

FIG. 4 is a view illustrating the spatiotemporal information on events detected by a spatiotemporal event spotting model in an input video, represented as a three-dimensional (3D) heatmap, according to an example.

FIG. 5 is a view illustrating the spatiotemporal information on an event detected in a frame of an input video by a spatiotemporal event spotting model, based on a 3D heatmap, according to an example.

FIG. 6 is a view for describing the flowchart of a method of training a spatiotemporal event spotting model according to an embodiment.

### DETAILED DESCRIPTION OF THE INVENTION

The terms used in this specification may vary, in consideration of the functions used in the invention, depending on the intentions of the user or operator, or established practices. Therefore, the definition of the present disclosure should be made based on the entire contents of the present specification. The terms used in the detailed description are provided only for describing the exemplary embodiments and should not be restrictive. Unless explicitly used otherwise, singular expressions include plural expressions thereof. In the present specification, the terms “comprises,” “comprising,” “includes,” “including,” “containing,” “has,” “having” or other variations thereof are provided to indicate specific components, numbers, steps, operations, elements, and some or combinations thereof, and it should not be construed to exclude the presence or possibility of one or more other components, numbers, steps, operations, elements, and some or combinations thereof other than those disclosed.

Terms “first”, “second”, and the like may be used to describe various constituent elements, but the constituent elements are of course not limited by these terms. These terms are merely used to distinguish one constituent element from another constituent element. Therefore, the first constituent element mentioned hereinafter may be the second constituent element within the technical spirit of the present invention.

In addition, the embodiments disclosed in the present specification may have a configuration that is hardware as a whole, hardware partially, software partially, or software as a whole.

In the present disclosure, the term “module” or “unit” refers to a component that performs at least one function or operation, and may be implemented as hardware, software, or a combination of both hardware and software. In addition, a plurality of “modules” or “units,” except for those “modules” or “units” that need to be implemented with specific hardware, may be integrated into at least one module and implemented with at least one processor.

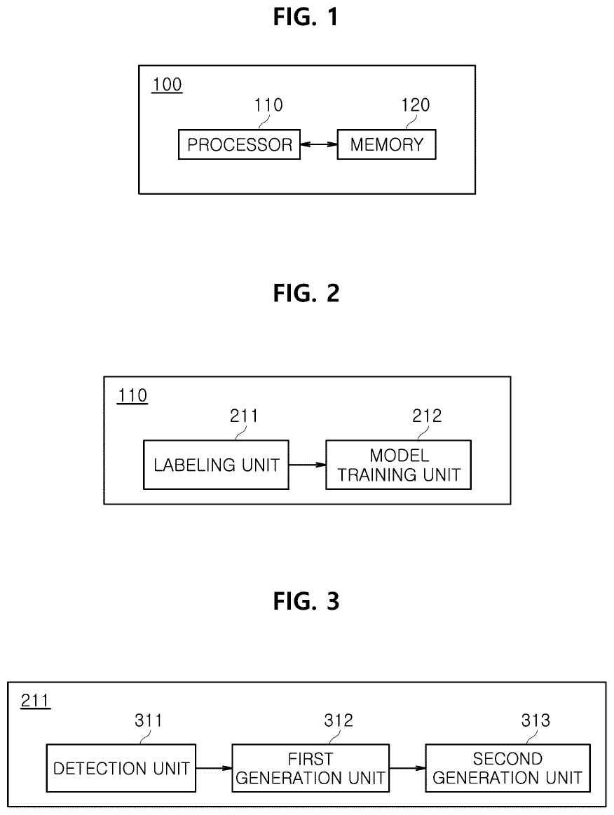

FIG. 1 is a block diagram for describing an apparatus 100 for training a spatiotemporal event spotting model according to an embodiment.

With reference to FIG. 1, the apparatus 100 for training a spatiotemporal event spotting model includes a processor 110 and a memory 120.

The processor 110 controls the overall operation performed by the apparatus 100 for training a spatiotemporal event spotting model. The processor 110 may perform processing operations for training a spatiotemporal event spotting model through instructions stored in the memory 120.

For example, the processor 110 may include one or more of a digital signal processor (DSP) 110, microprocessor 110, graphics processing unit (GPU), artificial intelligence (AI) processor 110, neural processing unit (NPU), central processing unit (CPU), microcontroller unit (MCU), micro processing unit (MPU), controller, application processor (AP) 110, communication processor (CP) 110, or ARM processor 110. In addition, the processor 110 may be implemented as a system on chip (SoC) or large-scale integration (LSI) with embedded processing algorithms, or as the form of an application-specific integrated circuit (ASIC) or field-programmable gate array (FPGA).

The memory 120 may store various data used by the processor 110. The data may include, for example, input data or output data for software (e.g., program), and commands related thereto. The memory 120 may include a volatile memory 120 or a non-volatile memory 120.

FIG. 2 is a block diagram for describing the modules of the apparatus 100 for training a spatiotemporal event spotting model according to an embodiment.

With reference to FIG. 2, the processor 110 includes a labeling unit 211 and a model training unit 212.

The labeling unit 211 assigns spatiotemporal labels to the training data for training the spatiotemporal event spotting model. The labeling unit 211 identifies specific events in a target video and assigns spatiotemporal labels corresponding to the specific events.

Here, the spatiotemporal label may be defined as a pair of spatial information and temporal information on the occurrence of a specific event in each frame constituting the target video. Specifically, the spatiotemporal label may include occasion information on when a specific event occurred in each frame constituting the target video, as well as pixel coordinates where the specific event occurred in each frame.

For example, the labeling unit 211 may identify game events occurring in a target video capturing a ball sports game, detect the occasion information on when the game event occurred in each frame constituting the target video and the location coordinates where the event occurred, and assign spatiotemporal labels to the corresponding game event.

That is, the labeling unit 211 assigns spatiotemporal labels to the data used for training the spatiotemporal event spotting model, thereby constructing the training data.

The model training unit 212 trains the spatiotemporal event spotting model based on the training data constructed by the labeling unit 211. Specifically, the model training unit 212, based on the training data, trains the spatiotemporal event spotting model so that when an input video is received, the model identifies specific events in the input video, extracts the spatiotemporal information on the specific events, and represents the spatiotemporal information as a 3D heatmap.

Here, the spatiotemporal event spotting model may include a model based on artificial intelligence that spatially and temporally detects events in the input video.

In other words, the spatiotemporal event spotting model refers to a model that not only detects whether an event occurs in the input video but also detects at what occasion and at what coordinates the event occurs in the input video (i.e., spatiotemporal information on the event).

As an example, the spatiotemporal event spotting model may refer to a model trained to extract the spatiotemporal information on key game events, such as attack, defense, assist, goal, conceded goal, foul, and more specific events like spike, receive, serve, set, score, miss, yellow card, and red card, from an input video recording of a ball sports game.

FIG. 3 is a block diagram for describing the detailed modules of the apparatus 100 for training a spatiotemporal event spotting model according to an embodiment.

With reference to FIG. 3, the labeling unit 211 includes a detection unit 311, a first generation unit 312, and a second generation unit 313.

The detection unit 311 detects the location information on one or more objects in the target video, which includes one or more frames.

In this case, one or more objects include at least one of a first object, a second object, and a third object. For example, when the target video is a footage that records a ball sports game, the first object may be the ball, the second object may be the referee, and the third object may be a player participating in the game.

Here, the location information may include coordinate information, direction information, angle information, and speed information on each object in the frame. For example, the location information may include the pixel coordinates of an object on the frame at the time of the event, the direction the object is facing (e.g., the gaze direction in which the referee is looking at the ball, or the direction of movement of the ball, player, or referee), the movement angle of the object (e.g., shooting angle, passing angle), and the speed of the object (e.g., the speed of the ball, the movement speed of the player).

As an example, the detection unit 311 may detect the location information on the ball for each frame of the target video. The detection unit 311 may detect the gaze direction in which the referee is looking at the ball for each frame of the target video. The detection unit 311 may detect the location information on the player for each frame of the target video.

The first generation unit 312 generates pseudo-spatial data for the target object in the target video based on the respective location information on one or more objects.

First, the first generation unit 312 may generate spatial information on each object based on the location information detected by the detection unit 311. For example, the first generation unit 312 may generate spatial information on the first object based on the location information on the ball. As another example, the first generation unit 312 may generate spatial information on the second object based on the gaze direction of the referee. As another example, the first generation unit 312 may generate spatial information on the third object based on the location information on the player.

Subsequently, the first generation unit 312 may generate pseudo-spatial data for the target object based on at least one of the spatial information on the first object, the spatial information on the second object, or the spatial information on the third object.

In this case, the target object is one of the objects belonging to one or more objects, and may be, for example, the first object, the second object, or the third object.

Meanwhile, the pseudo-spatial data refers to the approximate location information on the target object. The pseudo-spatial data, as approximate information on the target object, may refer to the location where the target object is estimated to exist in the corresponding frame.

The second generation unit 313 generates the spatiotemporal information on an event related to the target object, which has a pair of pseudo-spatial data of the target object and temporal information at the time of detection.

The second generation unit 313, when the target object is the first object corresponding to the ball, may generate the spatiotemporal information on serve, receive, set, spike, score, and miss events, as events related to the ball.

The second generation unit 313 may construct training data for training the spatiotemporal event spotting model based on the spatiotemporal information on the event.

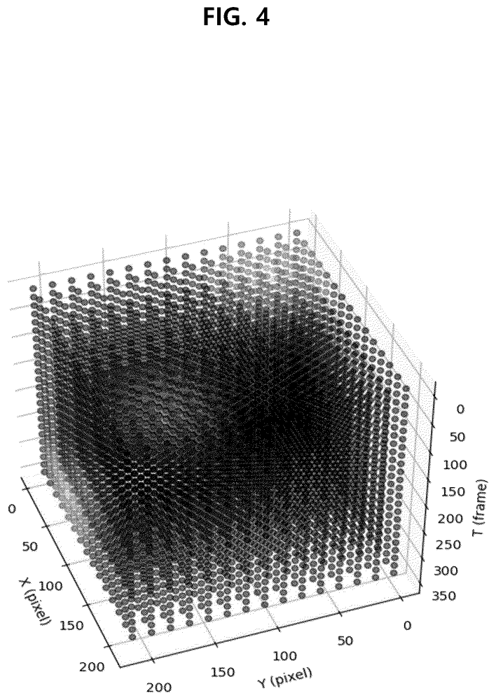

FIG. 4 is a view illustrating the spatiotemporal information on events detected by a spatiotemporal event spotting model in an input video, represented as a three-dimensional (3D) heatmap, according to an example.

The 3D heatmap visually represents the spatiotemporal data of events detected by the spatiotemporal event spotting model in the input video.

The 3D heatmap is a graph represented by the x-axis and y-axis of the pixel coordinate system applied to the target video, along with the time axis (t-axis) of the target video. In this case, in the 3D heatmap, an event is handled by both the spatial information (x, y coordinates) and the temporal information (t) on the event simultaneously, with the degree of the event's distribution probability represented by color.

Therefore, the spatiotemporal event spotting model according to an embodiment may visualize the points where events occur in the target video, allowing the information to be easily grasped at a glance.

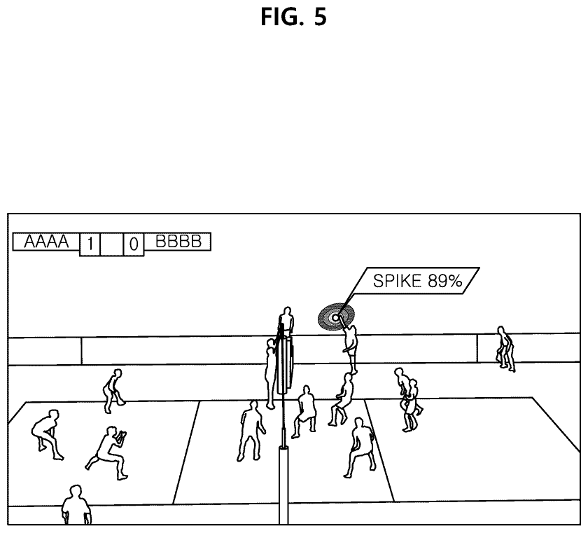

FIG. 5 is a view illustrating the spatiotemporal information on an event detected in a frame of an input video by a spatiotemporal event spotting model, based on a 3D heatmap, according to an example.

As illustrated in FIG. 5, the spatiotemporal event spotting model may visually represent the spatiotemporal information on an event in the frame itself, which is included in the target video, based on the 3D heatmap. In this case, the temporal information may be represented by the time at which the frame appears, and the spatial information may be identified by the pixel coordinates where the event occurred in the corresponding frame being colored differently.

As illustrated in FIG. 5, the spatiotemporal event spotting model trained by the apparatus described in this specification may visualize the spatiotemporal information on an event by applying color to the point where the spike occurs in the frame where the spike event takes place in a volleyball game.

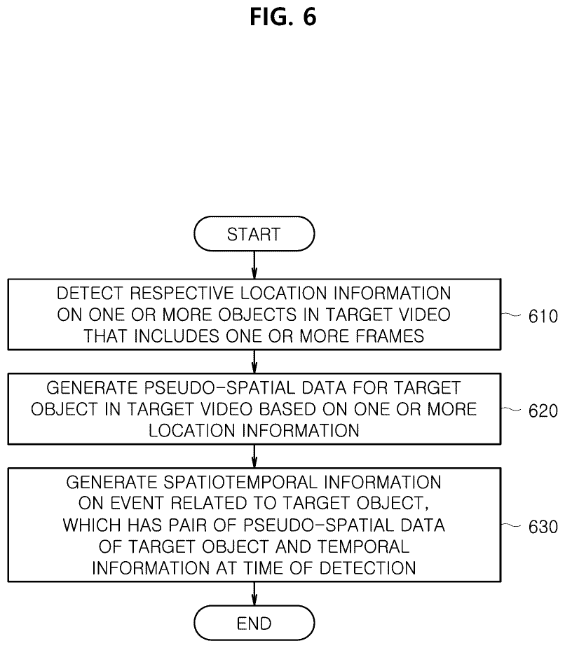

FIG. 6 is a view for describing the flowchart of a method of training a spatiotemporal event spotting model according to an embodiment.

The method of FIG. 6 may be performed by the apparatus 100 for training a spatiotemporal event spotting model illustrated in FIG. 1.

First, the apparatus 100 for training a spatiotemporal event spotting model detects the spatial information on one or more objects, respectively, in a target video, which includes one or more frames (610).

In this case, one or more objects include at least one of the first object, the second object, and the third object.

Subsequently, the apparatus 100 for training a spatiotemporal event spotting model generates pseudo-spatial data for the target object in the target video based on one or more spatial information (620).

In this case, the target object is one of the objects belonging to the one or more objects.

Subsequently, the apparatus 100 for training a spatiotemporal event spotting model generates the spatiotemporal information on an event related to the target object, which has a pair of the pseudo-spatial data of the target object and the temporal information at the time of detection (630).

Meanwhile, although the method of FIG. 6 is described in multiple steps, at least some of the steps may be performed in a different order, combined with other steps to be performed together, omitted, broken down into detailed steps, or one or more additional steps not illustrated may be added and performed.

While the present invention has been described in detail above with reference to the representative exemplary embodiments, those skilled in the art to which the present invention pertains will understand that the exemplary embodiment may be variously modified without departing from the scope of the present invention. Therefore, the scope of the present invention should not be limited to the described exemplary embodiments, and should be defined by not only the claims to be described below, but also those equivalent to the claims.

### DESCRIPTION OF REFERENCE NUMERALS

100: Apparatus for training spatiotemporal event spotting model
110: Processor
120: Memory
211: Labeling unit
212: Model training unit
311: Detection unit
312: First generation unit
313: Second generation unit

1. An apparatus for training a spatiotemporal event spotting model, comprising:
one or more processors; and
a memory storing instructions executed by the one or more processors,
wherein the one or more processors:
detect respective location information on one or more objects in a target video that includes one or more frames, wherein the one or more objects include at least one of a first object, a second object, or a third object;
generate pseudo-spatial data of a target object in the target video based on the one or more location information, wherein the target object is one of the objects belonging to the one or more objects; and
generate spatiotemporal information on an event related to the target object, which has a pair of pseudo-spatial data of the target object and temporal information at the time of detection.

2. The apparatus of claim 1, wherein the one or more processors train the model to extract the spatiotemporal information on the event in an input video, based on the spatiotemporal information on the event, when the input video is input to the model.

3. The apparatus of claim 2, wherein the one or more processors train the model to represent the spatiotemporal information on the event in a three dimensional (3D) heatmap format.

4. The apparatus of claim 3, wherein the spatiotemporal information on the event includes:
temporal information including an occasion when the event occurred in each frame; and
spatial information including location coordinates where the event occurred in each frame.

5. The apparatus of claim 3, wherein the 3D heatmap is configured to include an x-axis and a y-axis of a pixel coordinate system applied to the target video, and a time axis (t-axis) of the target video.

6. The apparatus of claim 1, wherein the target video is a video capturing a ball sports game, the first object is a ball, and the one or more processors detect location information on the ball and generate spatial information on the first object based on the location information on the ball.

7. The apparatus of claim 6, wherein the second object is a referee, and the one or more processors detect a gaze direction in which the referee is looking at the ball and generate spatial information on the second object based on the gaze direction of the referee.

8. The apparatus of claim 7, wherein the third object is a player possessing the ball, and the one or more processors detect location information on the player and generate spatial information on the third object based on the location information on the player.

9. The apparatus of claim 8, wherein the one or more processors generate pseudo-location information on the first object based on at least one of the spatial information on the first object, the spatial information on the second object, or the spatial information on the third object.

10. A method of training a spatiotemporal event spotting model, performed by an apparatus for training a spatiotemporal event spotting model, including one or more processors, and a memory storing instructions executed by the one or more processors, the method comprising:
detecting respective location information on one or more objects in a target video that includes one or more frames, wherein the one or more objects include at least one of a first object, a second object, or a third object;
generating pseudo-spatial data of a target object in the target video based on the one or more location information, wherein the target object is one of the objects belonging to the one or more objects; and
generating spatiotemporal information on an event related to the target object, which has a pair of pseudo-spatial data of the target object and temporal information at the time of detection.

11. The method of claim 10, comprising:
training the model to extract the spatiotemporal information on the event in the input video, based on the spatiotemporal information on the event, when an input video is input to the model.

12. The method of claim 11, wherein the training includes:
training the model to represent the spatiotemporal information on the event in a three dimensional (3D) heatmap format.

13. The method of claim 12, wherein the spatiotemporal information on the event includes:
temporal information including an occasion when the event occurred in each frame; and
spatial information including location coordinates where the event occurred in each frame.

14. The method of claim 13, wherein the 3D heatmap is configured to include an x-axis and a y-axis of a pixel coordinate system applied to the target video, and a time axis (t-axis) of the target video.

15. The method of claim 10, wherein the target video is a video capturing a ball sports game, and the first object is a ball,
wherein the detecting includes:
detecting location information on the ball, and
wherein the generating includes:
generating spatial information on the first object based on the location information on the ball.

16. The method of claim 15, wherein the second object is a referee,
wherein the detecting includes:
detecting a gaze direction in which the referee is looking at the ball, and
wherein the generating includes:
generating spatial information on the second object based on the gaze direction.

17. The method of claim 16, wherein the third object is a player possessing the ball,
wherein the detecting includes:
detecting location information on the player, and
wherein the generating includes:
generating spatial information on the third object based on the location information on the player.

18. The method of claim 17, wherein the generating includes:
generating pseudo-location information on the first object based on at least one of the spatial information on the first object, the spatial information on the second object, or the spatial information on the third object.
